(19) United States
(12) Patent Application Publication
(10) Pub. No.: US 2026/0025572 A1
(43) Pub. Date: Jan. 22, 2026

(54) TEXTURE IMAGE ACQUISITION APPARATUS, METHOD OF ACQUIRING TEXTURE IMAGE, AND IMAGING JIG

(71) Applicant: SEIKO EPSON CORPORATION, TOKYO (JP)

(72) Inventors: Mitsuhiro YAMASHITA, MATSUMOTO-SHI (JP); Takuya ONO, SHIOJIRI-SHI (JP); Takahiro KAMADA, MATSUMOTO-SHI (JP); Yuko YAMAMOTO, SHIOJIRI-SHI (JP)

(21) Appl. No.: 19/270,715

(22) Filed: Jul. 16, 2025

(30) Foreign Application Priority Data
Jul. 19, 2024 (JP) 2024-116006

(51) Int. Cl. H04N 23/60; G06T 5/70; G06T 5/73; G06T 7/00; G06T 7/13; G06T 7/40; H04N 1/60

(52) U.S. Cl. CPC H04N 23/64; G06T 5/70; G06T 5/73; G06T 7/001; G06T 7/13; G06T 7/40; H04N 1/603; H04N 1/6094; G06T 2207/10024; G06T 2207/30144; G06T 2207/30168

(57) ABSTRACT

An imaging jig includes a comparison pattern surrounding a window portion configured as a light-transmissive region having a predetermined shape and including at least a first region and a second region having different tones. By using the imaging jig, a capture image including a medium and the comparison pattern is captured while the imaging jig overlaps with the medium. From the captured image being captured, medium image data based on the image of the medium and comparison image data based on the image of the comparison pattern are acquired, and the medium image data is corrected based on image data relating to the first region and the second region that are included in the comparison image data. Then, an image of a texture of the medium is extracted from the medium image data being corrected.

The present application is based on, and claims priority from JP Application Serial Number 2024-116006, filed Jul. 19, 2024, the disclosure of which is hereby incorporated by reference herein in its entirety.

### BACKGROUND

### 1. Technical Field

The present disclosure relates to a technique of acquiring an image of a texture.

### 2. Related Art

There has been known a technique of reading a texture of a target object that may be a recording medium. For example, JP-A-6-86045 discloses a method of acquiring a synthesized image of a texture in which a texture image data is synthesized with luminance information relating to image data or chrominance information relating texture image data is synthesized with chrominance information relating to image data, thereby preserving the hue and saturation while minimizing variations in the overall luminance of the synthesized image.

However, in such a technique, there have been issues such as the need for strict color management of a reference chart itself and the difficulty of dealing with unevenness that is location-dependent, such as uneven lighting, when using gamma curve correction.

### SUMMARY

The present disclosure can be achieved as the following embodiments or application examples.
(1) An aspect of the present disclosure is an aspect as a texture image acquisition apparatus that acquires a texture image of a medium. The texture image acquisition apparatus includes an imaging jig including a comparison pattern surrounding a window portion configured as a light-transmissive region having a predetermined shape and including at least a first region and a second region having different tones, an imaging unit configured to capture an image while the imaging jig overlaps with the medium, the image being an captured image including the medium in the window portion and the comparison pattern, a correction unit configured to acquire, from the captured image, medium image data based on the image of the medium and comparison image data based on the image of the comparison pattern, and correct the medium image data, based on image data relating to the first region and the second region that are included in the comparison image data, and an extraction unit configured to extract an image of a texture of the medium from the medium image data being corrected.
(2) Another aspect of the present disclosure is an aspect as an imaging jig for capturing an image of a texture of a medium. The imaging jig includes a window portion being provided at the center of the imaging jig and being configured as a region having a predetermined shape, and a comparison pattern surrounding the window portion and including at least a first region and a second region having different tones. Herein, the first region is circumscribed with the window portion to surround the window portion, the second region surrounds the first region on the outer side with respect to the first region, and outer peripheral shapes of the first region and the second region are similar to each other and share a center point with the window portion.
(3) The present disclosure can be implemented in various modes such as a method of acquiring a texture image by the texture image acquisition apparatus using the imaging jig and a computer-executable program for acquiring a texture image of a medium.

### BRIEF DESCRIPTION OF THE DRAWINGS

FIG. 1 is an explanatory diagram for illustrating a schematic configuration of a texture image acquisition apparatus of an embodiment.

FIG. 2 is a cross-sectional view taken along the X-Z plane at the position II-II in FIG. 1.

FIG. 3 is a plan view illustrating an example of a state in which an imaging jig overlaps with a subject.

FIG. 4 is a functional block diagram of the texture image acquisition apparatus.

FIG. 5 is an explanatory diagram for illustrating an overview of correction processing executed in the texture image acquisition apparatus.

FIG. 6 is an explanatory diagram for illustrating an overview of the correction processing.

FIG. 7 is a flowchart illustrating an example of a texture image acquisition processing routine.

FIG. 8 is an explanatory diagram for illustrating an example of field angle correction.

FIG. 9 is an explanatory diagram for illustrating a state of contrast correction.

FIG. 10 is an explanatory diagram for illustrating an overview of luminance correction.

FIG. 11 is an explanatory diagram for illustrating a state of extracting a texture image.

FIG. 12 is an explanatory diagram for illustrating first to third modified examples as other embodiments of the imaging jig.

FIG. 13 is an explanatory diagram for illustrating fourth and fifth modified examples as other embodiments of the imaging jig.

FIG. 14 is an explanatory diagram for illustrating another embodiment of the imaging jig.

FIG. 15 is an explanatory diagram for illustrating a sixth modified examples as another embodiment of the imaging jig.

### DESCRIPTION OF EMBODIMENTS

### A. First Embodiment

### (A1) Overall Configuration:

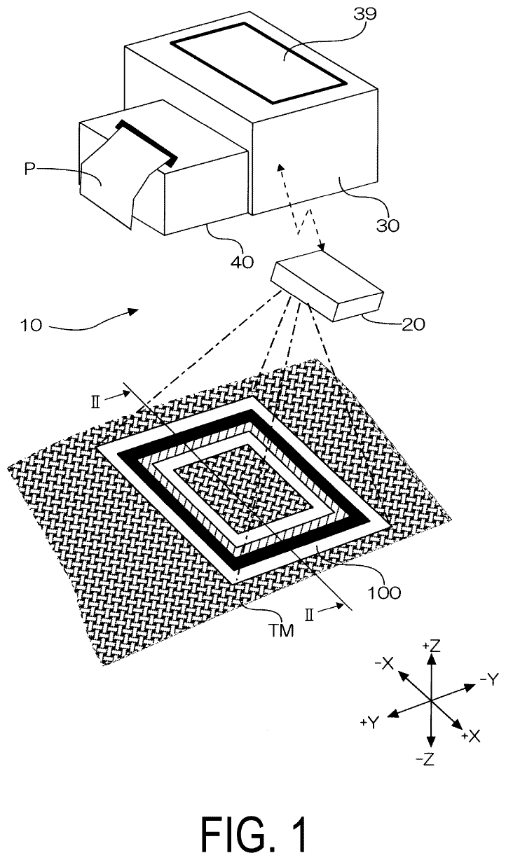

FIG. 1 is an explanatory diagram for illustrating a schematic configuration of a texture image acquisition apparatus 10 of a first embodiment. As illustrated in the drawing, the texture image acquisition apparatus 10 includes an imaging unit 20 that captures an image of a texture of a subject TM, an image processing device 30 that receives the image from the imaging unit 20 to acquire a texture image, a printer 40 that receives an output from the image processing device 30 to execute printing on a printing medium P, and an imaging jig 100 that is arranged on the subject TM and assists imaging of the texture. As described in the drawing, a downward direction along the gravitational direction is referred to as a +Z direction, a plane orthogonal to the Z direction is referred to as an X-Y plane, one direction on the plane is referred to as a +X direction, and a direction orthogonal to the +X direction is referred to as a +Y direction. Further, directions opposite to the +Z, +X, and +Y directions are referred to as −Z, −X, and −Y directions, respectively. Further, when the orientation is not a concern, the directions may simply be referred to as the Z, X, and Y directions. The Z, X, and Y directions are also shown as appropriate in the other drawings.

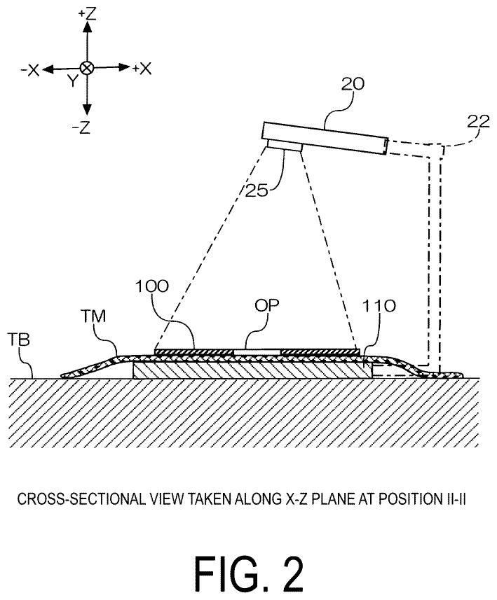

The imaging jig 100 is placed on the subject TM, and is used. The subject TM is set in a state substantially along the X-Y plane, and the imaging jig 100 is placed thereon. This state is illustrated in FIG. 2. FIG. 2 is a cross-sectional view taken along the X-Z plane at the position II-II in FIG. 1. In the drawing, a placement stand 110 is set on a table TB, the subject TM is placed thereon, and the imaging jig 100 is further set to overlap therewith. At the center of the imaging jig 100, a square window portion OP configured as a light-transmissive region having a polygonal shape. The imaging jig 100 is only required to have such rigidity that prevents distortion in a state being arranged on the subject TM, and various materials such as a thin metal plate, a synthesized resin sheet, and a thick paper sheet may be used. When the material of the imaging jig 100 can be subjected to printing by a printer or the like, a pattern may be printed hereon by the printer 40 or other printing apparatuses. The window portion OP, and the shape and the color of the pattern provided in the periphery thereof are described later in detail. Note that the window portion OP may be left as a cut-out in the imaging jig 100, or may be configured to be covered with transparent thin glass or synthetic resin. Alternatively, a first region AR1 and a second region AR2 may be printed with white ink and black ink, respectively, on a transparent sheet, and the window portion OP may be formed as an unprinted region. In such a case, a buffer region AB may also be printed with gray ink, for example. When a transparent sheet is subjected to printing, a surface on the imaging unit 20 side may be set as a printing surface so that reflection light by the transparent sheet is prevented from directly entering the imaging unit 20.

In the embodiment, as the imaging unit 20, a mobile phone including a camera 25 is used. The imaging unit 20 is connected to the image processing device 30 via wireless communication, and transmits captured image data and the like to the image processing device 30. Instead of a mobile terminal such as a mobile phone, a single camera may be used as the imaging unit 20. Connection between the imaging unit 20 and the image processing device 30 is not limited to wireless communication, and may be wired communication using a cable or the like. Further, a user may hold the imaging unit 20 in the hand to execute imaging. Alternatively, as indicated with the one-dot chain line in FIG. 2, a stand 22 provided continuously to the placement stand 110 may be used, and the imaging unit 20 may be fixed thereto and used. The stand 22 may stand independently on its own.

### (A2) Configuration of Imaging Jig 100:

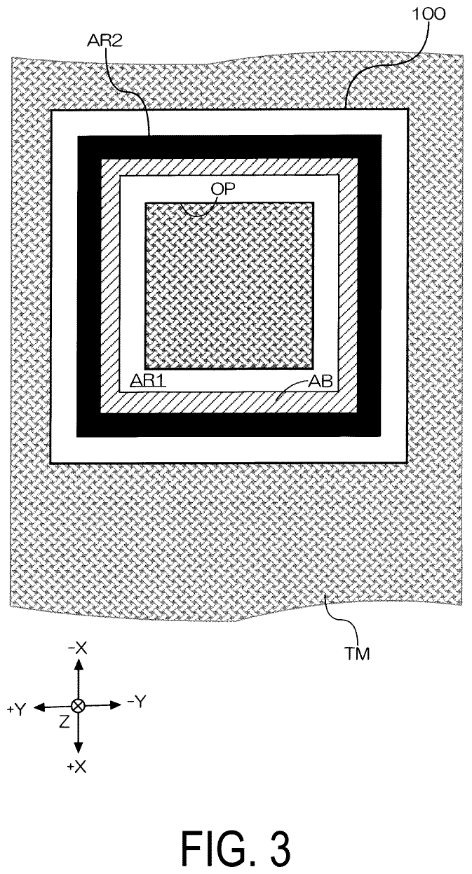

FIG. 3 is a plan view of the imaging jig 100. In the drawing, the imaging jig 100 is set to overlap with the subject TM. The window portion OP provided at the center of the imaging jig 100 has a square shape, and the three regions are provided concentrically with the center point of the window portion OP in the outer periphery of the window portion OP. In the periphery of the window portion OP, the first region AR1 is formed. The first region AR1 has a rectangular outer peripheral shape concentric with the window portion OP, and is arranged to be circumscribed with the window portion OP and surround the window portion OP. The color of the first region AR1 is white in the first embodiment. On the outer side of the first region AR1, the buffer region AB is provided. The color of the buffer region AB is gray. On the outer side of the buffer region AB, the second region AR2 is formed. The second region AR2 has a rectangular outer peripheral shape concentric with the window portion OP, is formed to surround the first region AR1 on the outer side with respect to the first region AR1. The color of the second region AR2 is black. On the outer side of the second region AR2, a region having a base color of the imaging jig 100. However, the region with the base color may not be provided. In the first embodiment, a region including the first region AR1, the buffer region AB, and the second region AR2 forms a comparison pattern. The outer peripheral shapes of those regions are similar to each other and share the center point with the window portion OP. Note that the comparison pattern may not include the buffer region AB.

It is assumed that the first region AR1 is white. However, when the imaging jig 100 is white paper, its base color may be used. Further, it is assumed that the second region AR2 is black. Based on the white color of the first region AR1 and the black color of the second region AR2, differences in the appearance of the subject TM due to lighting or the like are corrected. Specific contents of such luminance correction are described later. When the first region AR1 has L*=100 in an L*a*b color space, and the second region AR2 has L*=0 in the L*a*b color space, the full range of luminance L* can easily be corrected. The first region AR1 and the second region AR2 are only required to have different tones, in this case, luminance L*, and the tones may be reversed. Further, each of the regions may have a value other than L*=0 or L*=100. the luminance L* if each of the regions may be measured under standard lighting. Further, the buffer region AB is a buffer region provided between the first region AR1 and the second region AR2. This is because, in a case in which imaging is executed by the imaging unit 20, when regions with significantly different luminance are adjacent to each other, a function such as edge extraction built into the imaging unit 20 may be activated, and the luminance at the boundary between the respective regions may not be accurately reflected during the imaging. When a so-called smartphone is used as the imaging unit 20, such a function may be activated to produce a so-called visually pleasing photograph. The buffer region AB is positioned between the first region AR1 and the second region AR2 to suppress or avoid a function such as tone correction associated with edge extraction. Therefore, in an environment where such a correction function is not activated, the buffer region AB may be omitted. Note that, in the following description, the notation in the L*a*b color system may be simply referred to as Lab to avoid redundancy.

### (A3) Acquisition of Texture Image:

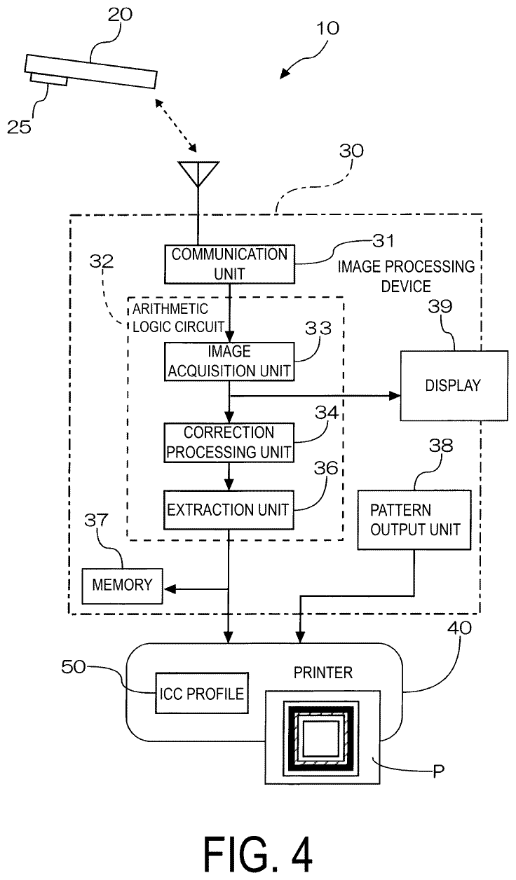

The functional configuration of the image processing device 30 is illustrated in FIG. 4. As illustrated in the drawing, the image processing device 30 includes a communication unit 31 that communicates with the imaging unit 20, an image acquisition unit 33 that acquires image data from the imaging unit 20 via the communication unit 31, a correction processing unit 34 that executes various types of correction with respect to the acquired image, an extraction unit 36 that extracts a texture image and outputs the texture image to a memory 37, a pattern output unit 38 that prints a pattern of the imaging jig 100 by using the printer 40, a display 39 that displays the captured image acquired by the image acquisition unit 33 or a message, and the like. The extraction unit 36 may not only store the extracted texture image in the memory 37, but also output the extracted texture image to the printer 40 to print the texture image on the printing medium P. The image processing device 30 includes an arithmetic logic circuit 32 including a publicly-known CPU and a storage device, and the image acquisition unit 33, the correction processing unit 34, the extraction unit 36, and the like are implemented by the operation of the CPU executing a predetermined program.

The communication unit 31 communicates with the imaging unit 20 through Bluetooth (registered trademark), WiFi (registered trademark), or the like. The image acquisition unit 33 acquires the image data via the communication unit 31. The acquired image data includes a medium image including a texture and an image of the comparison pattern. The correction processing unit 34 acquires medium image data based on the image of the subject TM and comparison image data based on the image of the comparison pattern of the imaging jig 100, and corrects the medium image data, based on the image data relating to the first region and the second region that are included in the comparison image data.

The extraction unit 36 extracts the image of the texture of the subject TM from the corrected medium image data, and stores the image in the memory 37 or outputs the printer 40 to print the image on the printing medium P. The memory 37 may be embedded in the image processing device 30, or may be in a form of an externally attached USB memory or the like. Herein, an ink-jet printer capable of execute full-color printing is used as the printer 40. However, any type of printer that can reproduce an image with a specified gradation, such as a dye-sublimation printer, is acceptable. Note that, in place of the printer, a display may be used. When the printer 40 can specify and reproduce device-independent colors including tones through an ICC profile 50, the comparison pattern of the imaging jig 100 may be printed as illustrated in the drawing. In such a case, the comparison pattern data in which one of the first region AR1 and the second region AR2 is white, the other one is black, and the buffer region AB is gray may be output from the pattern output unit 38 of the printer 40. In the printer 40, the comparison pattern may be printed on the printing medium P through the output ICC profile 50. Herein, the color of each of the regions may be defined by using the RGB color system. For example, the white color of the first region AR1 may be defined as R, G, B=(255, 255, 255), and the black color of the second region AR2 may be defined as R, G, B=(0, 0, 0). As the RGB color system, a publicly-known SRGB, AdobeRGB (“Adobe” is a registered trademark), DisplayP3, or the like may be used. Further, the values of the respective colors in the L*a*b color system corresponding to such R, G, and B values or the values of the respective colors in the CMYK color system may also be used. The window portion OP is cut out after printing. In this manner, the imaging jig 100 can easily be produced. Note that, as an example, the gray color in the buffer region AB may be R, G, B=(128, 128, 128). However, as described above, the buffer region AB in the embodiment is not provided for the purpose of the luminance correction or the like. Thus, the color and the luminance are freely selected as long as they do not match with those in the first region AR1 and the second region AR2.

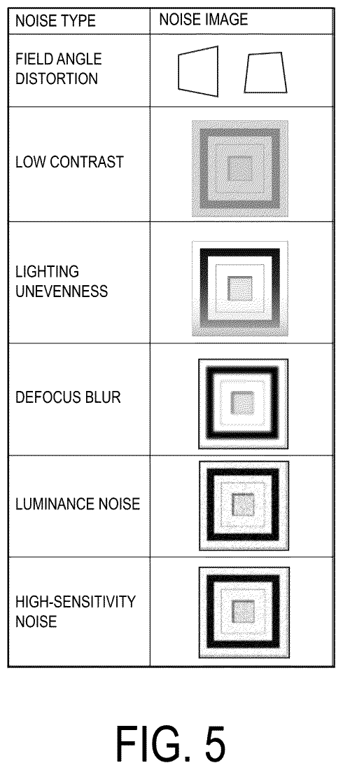

The captured image acquired by executing imaging by the imaging unit 20 includes various types of noise. When the texture of the subject TM is extracted, such noise needs to be removed. With reference to FIG. 5, noise that may be included in the captured image is described below. However, not all the types of noise necessarily require removal processing. This point is also described.
[1] Field angle distortion: when the imaging unit 20 does not directly face the subject TM, the shape of the subject TM that is defined by the window portion OP having a square shape is captured as a shape distorted from the square shape, as illustrated in the noise image column. The texture of the subject TM itself is also distorted similarly to the outer shape. Thus, to reproduce the texture correctly, field angle distortion is corrected. As described later, field angle correction can be executed by coordinate transformation such as affine transformation. As illustrated in FIG. 2, when the stand 22 is used so that the imaging unit 20 faces the subject TM accurately, field angle distortion does not occur, or is made negligibly small. In such a case, correction of field angle distortion may not be executed.
[2] Low contrast: when contrast of the image captured by the imaging unit 20 is lower than actual contrast, the contrast s improved. Contrast improvement can be achieved by correcting the contrast of the acquired image, but it can also be achieved by changing the exposure conditions (aperture and exposure time) of the imaging unit 20. When the imaging unit 20 is set to executed automatic exposure adjustment to capture an image with sufficient contrast, correction on the image processing device 30 side may be omitted in some cases.
[3] Lighting unevenness: unevenness is caused in lighting with respect to the subject TM. Lighting unevenness is caused by various factors. For example, various factors may contribute, such as the angle between a lighting light source and the subject TM, the differences in distance from the light source to each position on the subject TM, the shape of the light source, variations in light emission from the light source itself, and reflections from the imaging unit 20 or the like. Such lighting unevenness can be perceived as luminance unevenness in the first region AR1 or the second region AR2, and can be corrected by executing the luminance correction.
[4] Defocus blur: due to factors such as deviation of a focal position during imaging by the imaging unit 20 or excessive exposure time, the resulting image may become a so-called out-of-focus image or a defocus blur image, as illustrated as a noise image. In such a case, sharpening processing using an edge enhancement filter, such as a differential filter like a Sobel filter, may be considered. Note that when defocus blur is caused by an imaging condition of the imaging unit 20, it is also conceivable to change the imaging condition and execute imaging by the imaging unit 20 again.
[5] Luminance noise: luminance noise indicates noise generated in a luminance channel. In general, luminance noise is generated due to high sensitivity of the imaging unit 20. When an image signal from the imaging unit 20 is processed, luminance noise is treated as noise generated in L being a brightness component. Luminance noise is easily generated when the ISO sensitivity of the imaging unit 20 is high, or the like.
[6] High-sensitivity noise: high-sensitivity noise is noise generated when the sensitivity of the imaging unit 20 is excessively high, and is noise in which a non-existent color is added.

Luminance noise and high-sensitivity noise can be reduced by using a blurring filter. As the blurring filter, an averaging filter that takes the average value of a predetermined number of pixels, or the like may be used. For luminance noise, in the Lab color system, the luminance component L may be averaged mainly. For high-sensitivity noise, in the Lab color system, averaging may be executed including psychometric chroma coordinates a and b. Note that the correction processing for issues such as defocus blur, luminance noise, and high-sensitivity noise is not mandatory, and may be executed optionally. Further, a user may determine whether to execute the processing.

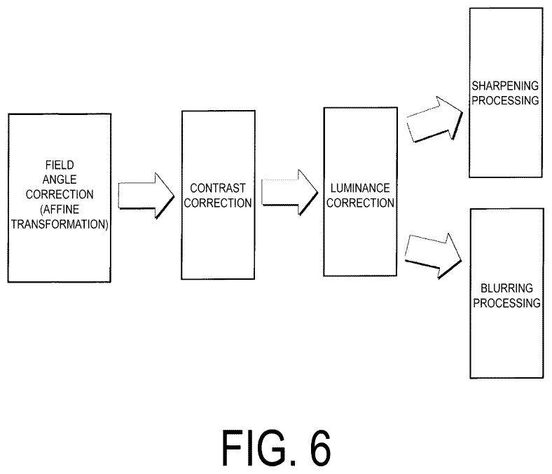

An example of the correction processing for the above-mentioned types of noise is illustrated in FIG. 6. The captured image that is captured by the imaging unit 20 may include field angle distortion, inappropriate contrast, inappropriate luminance, inappropriate sharpness, and the like. In view of this, correction of field angle distortion, adjustment of contrast, adjustment of luminance, and adjustment of sharpness are executed for correction. The adjustment of sharpness corresponds to execution of any one of the sharpening processing for increasing sharpness and blurring processing for mitigating sharpness. In general, in the correction processing, the field angle correction, the contrast correction, the luminance correction, and the sharpening processing or the blurring processing are executed in the stated order.

### (A4) Texture Image Acquisition Processing:

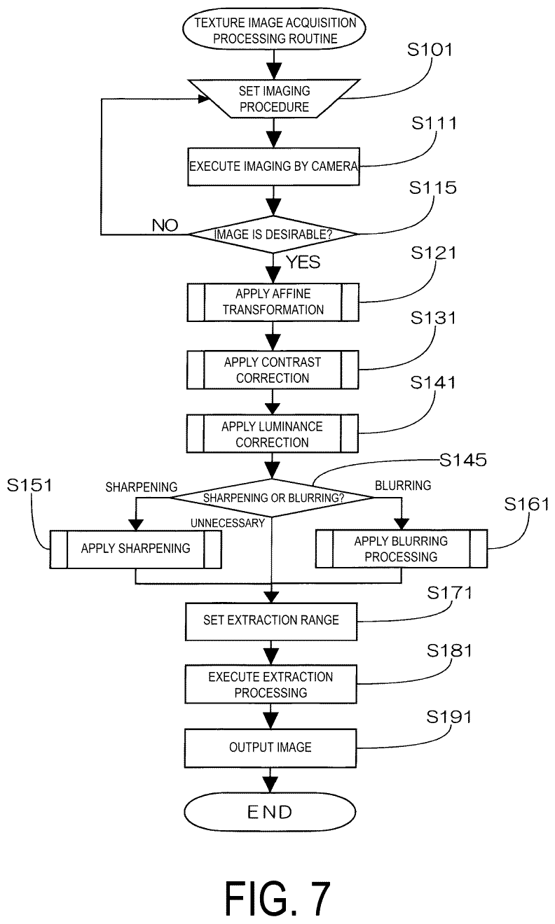

Texture image acquisition processing executed by the texture image acquisition apparatus 10 is described with reference to FIG. 7. Before the texture image acquisition processing, the above-mentioned imaging jig 100 is prepared, and the subject TM from which a texture is acquired is prepared. The texture image acquisition processing illustrated herein is implemented by executing a program, which is prepared in advance in the image processing device 30, by a computer. The program may be recorded in a ROM or the like provided to the image processing device 30, or may be downloaded from an external site and executed each time. Further, the program for coordinating the imaging unit 20 and the like may be prepared in the imaging unit 20 or the image processing device 30, and may be transmitted to the other side and executed as needed.

When the illustrated processing is started, setting processing for an imaging procedure is first executed (step S101). The setting processing for the imaging procedure includes processing of setting a position, brightness and a white balance of lighting, a position of the imaging unit 20, an angle with respect to the subject TM, and the like. Further, the processing may include processing of inputting the data relating to the imaging jig 100, for example, the size of the window portion OP and the colorimetric values of the colors of the first region AR1 and the second region AR2, and setting the type of correction executed after imaging and the filter.

Subsequently, imaging processing by the camera is executed (step S111). Specifically, the camera 25 of the imaging unit 20 captures an image of the subject TM on which the imaging jig 100 is placed to acquire a captured image including the subject TM being a subject that can be visually recognized through the window portion OP corresponding to the window portion and the comparison pattern on the imaging jig 100. It is determined whether the captured image being thus captured is a desired image (step S115). With regard to this determination, the captured image may be displayed on the display 39 provided to the image processing device 30, and a user may determine whether to adopt the captured image. Alternatively, the CPU or the like provided to the image processing device 30 may execute determination, based on the size of the window portion OP, the luminance of the first region AR1, and the like in the captured image. The captured image is not desirable (step S115: “NO”), the processing returns to step S101 again, and the processing is repeated from setting for the imaging procedure (step S101).

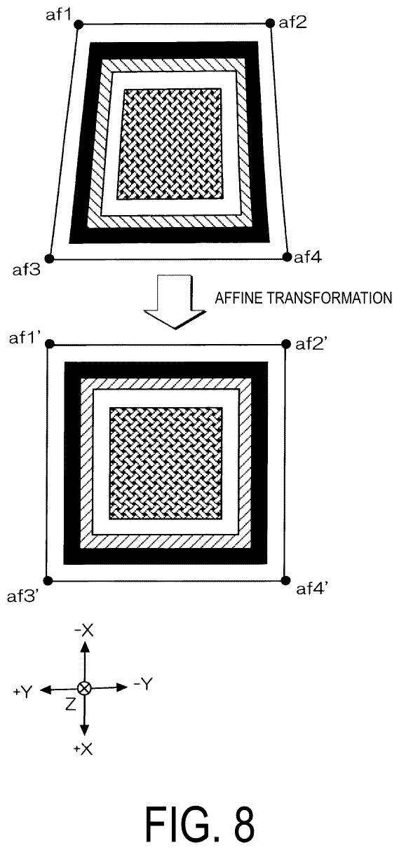

When it is determined that the desired image is obtained (step S115: “YES”), affine transformation is first applied to correct field angle distortion (step S121). A state of the affine transformation processing is illustrated in FIG. 8. Herein, as illustrated in the drawing, the outer shape of the imaging jig 100 is utilized. The outer shape of the imaging jig 100 has a rectangular (square) shape concentric with the center of the window portion OP, and the affine transformation is executed by using coordinates of four vertices af1 to af4 of the outer shape. Specifically, the affine transformation can be defined as in Expression (1) given below, where a coordinate before transformation is (x, y), and a coordinate after transformation is (x′, y′).

$$[ Math . 1 ]$$

$$\begin{matrix}[ Math . 1 ] & \\ ( \begin{matrix}{x}^{′} \\ {y}^{′} \\ 1\end{matrix} ) = ( \begin{matrix}a & b & c \\ d & e & f \\ 0 & 0 & 1\end{matrix} ) ( \begin{matrix}x \\ y \\ 1\end{matrix} ) & ( 1 )\end{matrix}$$

The coordinates (x, y) of the four vertices af1 to af4 of the outer shape of the imaging jig 100 can be specified by edge determination using a Sobel filter or the like with respect to the captured image. Further, the length of each of the sides of the imaging jig 100 is known. Thus, the coordinates (x′, y′) of the four vertices af1′ to af4′ can be defined by referring to the image resolution. By formulating a system of linear equations or solving it as an optimization problem using these four pairs of coordinates, the parameters of the matrix constituting the affine transformation, in other words, the parameters a to f in Expression (1) given above can be determined. After the matrix parameters are determined, Expression (1) may be applied to all the pixels constituting the captured image to obtain the coordinates after the transformation.

The correction of field angle distortion using the affine transformation is assumed to be applied by default. However, when it is determined from the coordinates of the four vertices that no correction is necessary, the processing in step S121 may be skipped. Further, depending on the intended use after acquiring the texture, a certain level of resolution may be required. In such a case, resolution conversion may be executed simultaneously at the timing of the affine transformation. When the resolution is increased, for example, when the resolution is doubled, new pixels are provided between adjacent pixels. The gradation values of the new pixels may be set by interpolation, based on the gradation values of the adjacent existing pixels. Note that the correction of field angle distortion may also be executed by using coordinate transformation methods other than the affine transformation, such as orthographic projection or perspective transformation.

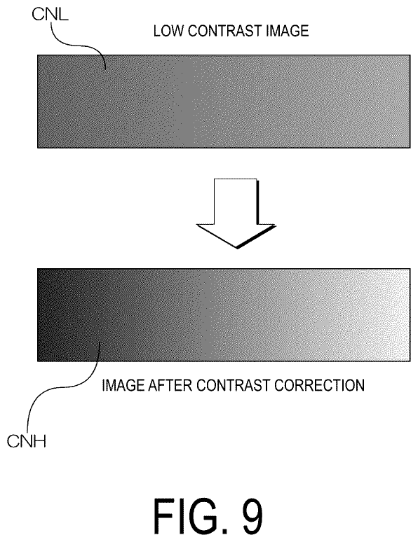

Subsequently, the image after correcting field angle distortion is subjected to contrast correction (step S131). The contrast correction is executed as a countermeasure when the dynamic range of the captured image is narrow, resulting in a low contrast image. An example in which a low contrast image is corrected to produce an image with enhanced contrast is illustrated in FIG. 9. In the drawing, a low contrast image CNL and a corrected image CNH after the correction are illustrated in comparison. It can be seen that the range of luminance L in the original image is expanded through the correction.

In the embodiment, the contrast correction is executed by using the average luminance Lw of the first region AR1 being a white region and the average luminance Lb of the second region AR2 being a black region in the captured image. Thus, the outer shapes of the first region AR1, the second region AR2, and even the window portion OP are specified from the image after the affine transformation. In the image after the affine transformation, the four vertices of each of the regions (including the buffer region AB) having a rectangular shape are recognized through edge detection, and coordinates thereof are acquired. With this, the outer shape of each of the regions can be specified.

In the captured image, luminance of a pixel g present in the region of the window portion OP in the captured image is defined as image luminance Lg. Then, contrast of a low contrast image can be enhanced by executing computation using Expression (2) given below. As a result, an image with improved contrast can be obtained.

$${Lg}^{′} = f ( Lg ) = \{ ( Lg - Lb ) / ( Lw - Lb ) \} \times ( LW 0 - LB 0 ) \qquad ( 2 )$$

The variables in Expression (2) are as follows. Note that, in the following description, “white” corresponds to the color of the first region AR1, and “black” corresponds to the color of the second region AR2.
Lb: the black color of the imaging jig 100 in the captured image
Lw: the white color of the imaging jig 100 in the captured image
LB0: the black color of the imaging jig 100 itself
LW0: the white color of the imaging jig 100 itself

In an example, it is assumed that the captured image is a low contrast image and, in the captured image, the average luminance Lb of the second region AR2 is 20, and the average luminance Lw of the first region AR1 is 60. In contrast, as described above, the luminance of the first region AR1 itself in the imaging jig 100 is LW0=100, and the luminance of the second region AR2 itself is LB0=0. Therefore, Lg′={(Lg−20)/(60−20)}×(100−0) is obtained based on calculation using Expression (2). When the luminance Lg of the pixel in the captured image is a value of 60, Lg′=100. When the luminance Lg of the pixel in the captured image is a value of 20, Lg′=0. Thus, it can be seen that the dynamic range of the image is expanded and the contrast is improved.

When the captured image by the imaging unit 20 is represented in the RGB values, the RGB values of the captured image may first be converted into the Lab color system using a color space profile to obtain the luminance (L). Then, the contrast correction is executed in the Lab space, and after the correction, the values are converted back to RGB values using the inverse of the color space profile. As a matter of course, when the texture image is used as it is in the Lab color system, the texture image may be handled in the Lab color system throughout, without executing the inverse transformation.

The correction described above stretches the gradation values of respective pixels. Thus, when the original image has a narrow range of gradation values, the correction may result in perceptible step-like changes. In such a case, the low contrast correction described above may be skipped, and the processing may return to step S101 to redo the processing starting from imaging. In this case, it is also effective to preview the obtained captured image that is initially obtained, determine parameters for exposure correction by using the luminance value of the white color in the first region AR1 and the luminance value of the black color in the second region AR2 that are included in the image, and feedback the parameters to the imaging setting (step S101).

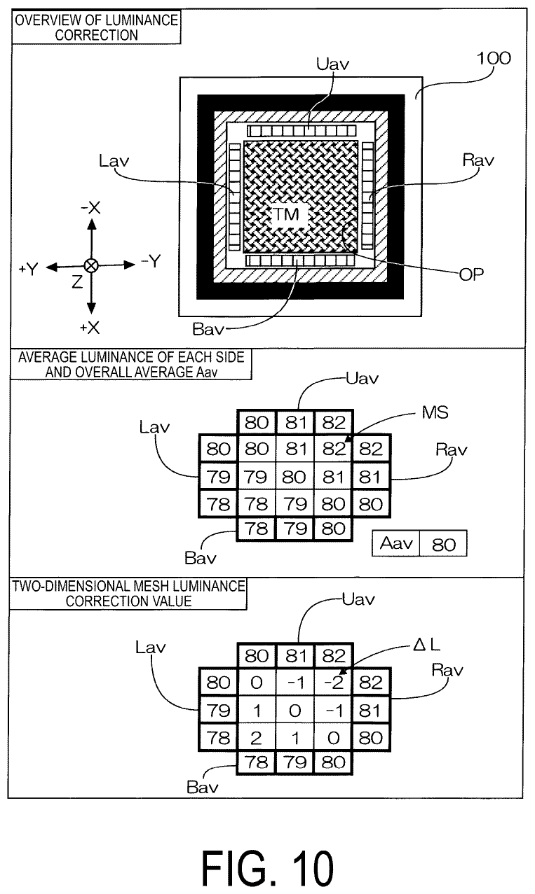

After the captured image is subjected to the contrast correction (step S131), the captured image is sequentially subjected to the luminance correction (step S141). The luminance correction can be executed by the following procedures <1> to <6>. Note that the captured image is handled as an image converted into the Lab color space. A state of the luminance correction is illustrated in FIG. 10. The description is made below referring to the drawing as appropriate.
<1> The rectangular position of the first region AR1 is specified from the captured image by edge determination. Note that the image being a target of the luminance correction is an image after the correction of field angle distortion by the affine transformation and the contrast correction. Therefore, when the rectangular position of the first region AR1 is specified at the time of such correction, the rectangular position may be used directly. It is assumed that the pixel position in the first region AR1 is expressed by (x, y).
<2> Average luminance of the four sides in the first region AR1 is calculated by using luminance values L (x, y) of pixels forming an image in the first region AR1. In FIG. 10, with regard to the pixels in the first region AR1, average luminance Uav of the pixel positions in the upper side, average luminance Rav of the pixel positions in the right side, average luminance Bav of the pixel positions in the lower side, and average luminance Lav of the pixel positions in the left side are obtained. It is assumed that the average luminance of each pixel position (x, y) is expressed by Uav(x, y).
<3> The average luminance of the four edges is further averaged to obtain an overall average Aav.
<4>A two-dimensional mesh MS corresponding to all the pixels in the region surrounded by the four sides, in other words, the window portion OP is assumed based on the average luminance Uav(x, y), Rav(x, y), Bav(x, y), and Lav(x, y) of the four sides, and distribution Lip(x, y) of the luminance value L is obtained by interpolation.
<5>A luminance correction value AL for correcting the luminance Lg(x, y) of the pixel g at the position (x, y) is obtained based on Expression (3) given below.

$$Δ L ( x , y ) = Aav - Lip ( x , y ) \qquad ( 3 )$$

Herein, Lip(x, y) is not an actual luminance value of the image in the window portion OP, but the distribution of the luminance value L obtained based on the average luminance Uav(x, y), Rav(x, y), Bav(x, y), and Lav(x, y) of the four sides by interpolation.
<6> The luminance correction value ΔL(x, y) thus obtained is added to the actual luminance value L(x, y) at each pixel g (x, y) in the image in the window portion OP.

In this manner, the luminance value L(x, y) of each pixel g (x, y) is corrected.

The luminance correction described above is effective similarly to lighting unevenness when there are luminance differences depending between locations. Below is an example of obtaining a two-dimensional mesh of a luminance correction value ΔL, assuming that the size of the window portion OP is 3×3 pixels. In the middle part of FIG. 10, for the sake of description, the average luminance Uav(x, y), Rav(x, y), Bav(x, y), and Lav(x, y) of the four sides are illustrated as 1×3 or 3×1, and the distribution of the luminance values L obtained by interpolating these average values is illustrated as a 3×3 example. In practice, the mesh may be expanded in accordance with the number of pixels in the image in the window portion OP. When it is necessary to increase the precision of the luminance correction, the vertical direction is treated as the width corresponding to the plurality of pixels in a case of the horizontally long sides such as the average luminance Uax(x, y) and Bav(x, y), and the horizontal direction is treated as the width corresponding to the plurality of pixels in a case of the vertically long sides such as the average luminance Rav(x, y) and Lav(x, y). In this manner, the representative luminance may be obtained by averaging the luminance of the pixels arrayed in the width direction. Specifically, for example when Uav(x, y) includes 10 pixels in the x direction and 100 pixels in the y direction, the luminance values L over 10 pixels are averaged to produce a 1×100 luminance value L, which is then used as the average luminance Uav(x, y).

Herein, the correction amount AL of the luminance correction is determined by using information relating to the first region AR1 being a white region, and this is based on the assumption that a printing medium being a texture acquisition target often has a white base color, such as fabric. Therefore, when the printed medium being a texture acquisition target has a base color, more accurate correction can be achieved by providing the imaging jig 100 with a region with color information similar to the base color. As a matter of course, even when the subject TM has a base color, it is still acceptable to execute the correction by using the information relating to the white first region AR1. Additionally, in the present embodiment, the four sides are acquired from the first region AR1 adjacent to the window portion OP. However, the four sides may be acquired from a region at a different position as long as the region has a color other than complete black (L=0). In addition, in the embodiment, the luminance correction value ΔL is determined by the method using the two-dimensional mesh as described above. Instead, approach, the luminance correction value ΔL may be defined in a form of a lookup table LUT or a gamma curve.

Sequentially to the correction of field angle distortion by the affine transformation (step S121), application of the contrast correction (step S131), application of the luminance correction (step S141), which are described above, it is determined whether the image is subjected to the sharpening processing or the blurring processing (step S145). When the captured image thus obtained is out of focus, the sharpening processing is applied (step S151). When luminance noise or high-sensitivity noise is observed in the captured image, the blurring processing is applied (step S161). The sharpening processing and the blurring processing are mutually exclusive, and hence are not executed simultaneously.

The sharpening processing (step S151) can be easily achieved by applying an algorithm such as the Lucy-Richardson algorithm. The Lucy-Richardson algorithm is a method for sharpening in which the ratio between the defocus blur image being a target and an intentionally generated blurred image is multiplied by the defocus blur image. The Lucy-Richardson algorithm is a generalized method, and hence detailed description therefor is omitted.

On the other hand, as the blurring processing (step S161), a common blurring filter such as a Gaussian filter and a median filter is effectively adopted. The filter size may be determined based on factors such as the size of the obtained texture image being a target (the size of the window portion OP) and the shape of the texture. Note that, in general, when the blurring processing is executed, the characteristics of the obtained texture may be lost. Therefore, luminance noise or high-sensitivity noise may be limited to a level that does not significantly affect the texture. Specifically, the default filter size may be set to approximately 3×3, and a user may increase the size while observing the processing results. Note that the processing result may be evaluated not only by a user but also by a trained AI.

When the captured image is appropriate, both the sharpening processing and the blurring processing may be omitted (step S145: “unnecessary”), and the processing may proceed to step S171. By default, both the sharpening processing and the blurring processing are set to be not applied, and may be applied based on the determination by a user or the image analysis result. The image analysis may be executed based on the state of pixels in the first region AR1 or the second region AR2 of the imaging jig 100. For example, the edge intensity of the first region AR or the like may be compared with a threshold value. When the edge intensity is less than the threshold value, the sharpening processing may be applied. Alternatively, when the variance of the pixels in the first region AR1 or the like is large, and luminance noise or high-sensitivity noise is observed, the blurring processing may be applied. Note that, in either case, it is also possible to display, on the display 39, a notification recommending a user to return to step S101 and execute re-imaging when appropriate.

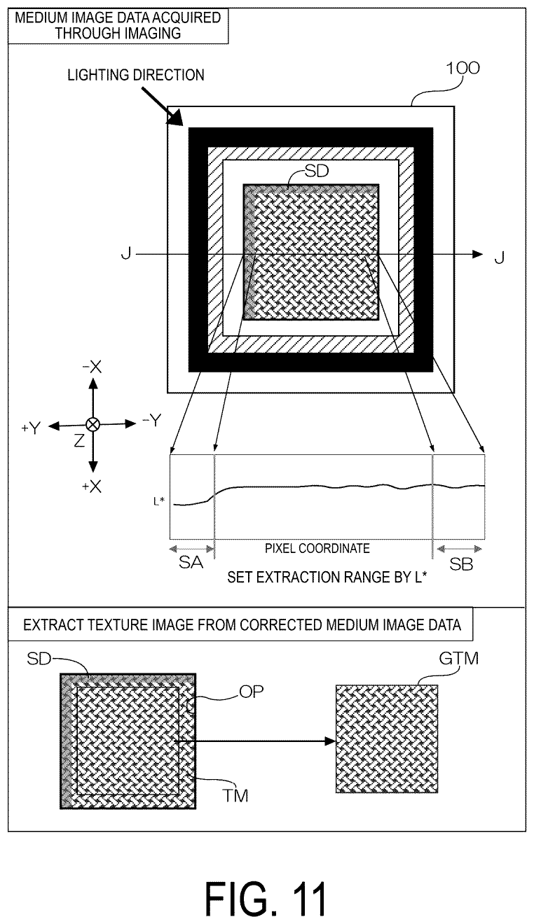

In step S171, an acquisition range being a range from which the texture image is extracted is set, and the image within the range is extracted (step S181). The texture image is an image of the subject TM that is visible through the window portion OP from the image of the entire imaging jig 100, which is captured and subjected to various types of correction. Instead of extracting the entire range of the window portion OP as the texture image, a range slightly inside of the window portion OP is set as the acquisition range of the texture image, and the image within the range is extracted. This state is illustrated in FIG. 11.

In the drawing, it is assumed that main lighting is applied to the imaging jig 100 from the upper left diagonally. In this case, on the subject TM in the window portion OP, shadow SD due to the thickness of the imaging jig 100 may be formed inside the outer shape of the window portion OP. As illustrated in the drawing, when the luminance L* of each pixel is measured along the line segment J-J passing through the center of the imaging jig 100 in the Y direction, within the window portion OP, a range SA in which the luminance L* is slightly decreased may be found inside the outer shape of the window portion OP. This is highly likely to be the shadow SD due to the thickness of the imaging jig 100 itself. Therefore, the range SA and a range SB having the same width on the opposite side with the center point sandwiched between the ranges are set as a predetermined range to be removed, and an image of a rectangular range excluding the range is cut out as a texture image GTM. Note that the cut-out range may also be set as a fixed range, such as a predetermined number of pixels inward from the boundary line of the window portion OP.

After the texture image is extracted as the set range, the texture image GTM is output to the memory 37 of the image processing device 30 (step S191). An output of the texture image GTM may be stored on a mobile terminal side when the imaging unit 20 is a mobile terminal such as a smartphone, or may be stored in a server on a network via communication. The texture image GTM to be stored may be printed on the printing medium P by the printer 40 for confirmation. When the texture image GTM is output, the present processing routine is terminated.

The texture image acquisition processing routine described above is executed. With this, the texture image acquisition apparatus 10 can acquire the texture of the subject TM by using the imaging jig 100 while suppressing the influence of various types of noise mixed in at the time of imaging. In the embodiment, the influence of field angle distortion, insufficient contrast, luminance unevenness, defocus blur, luminance noise/high-sensitivity noise, and the like can be suppressed. In particular, the influence of lighting unevenness that occurs depending on a location due to the distance from and arrangement of the light source can easily be suppressed or removed. As a result, the texture image GTM thus obtained is one in which the influence of various types of noise is suppressed or removed, and can be treated as one that accurately reproduces the actual state of the subject TM.

Further, when the first region AR1, the second region AR2, and the like of the imaging jig 100 are printed by the printer 40 including the ICC profile 50, and the printed resultant is used as the imaging jig 100, the imaging jig 100 may be generated at the desired timing, for example, every time an attempt is made to acquire the texture image. In this manner, there is no need to worry about discoloration of the color of the first region AR1 and the like of the imaging jig 100, or to manage the color development state. As a matter of course, the imaging jig 100 may be configured in a form that can be used over a long period of time by using a material that is unlikely to fade or discolor.

### B. Other Embodiments

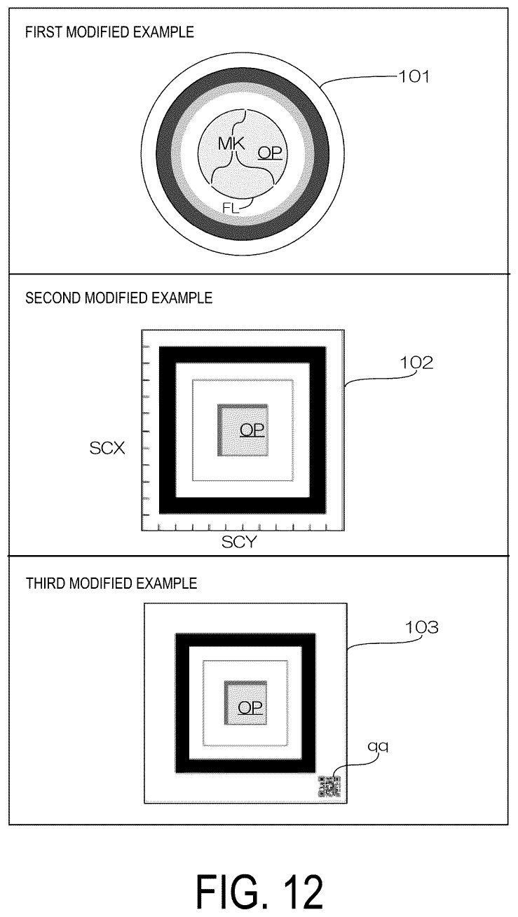

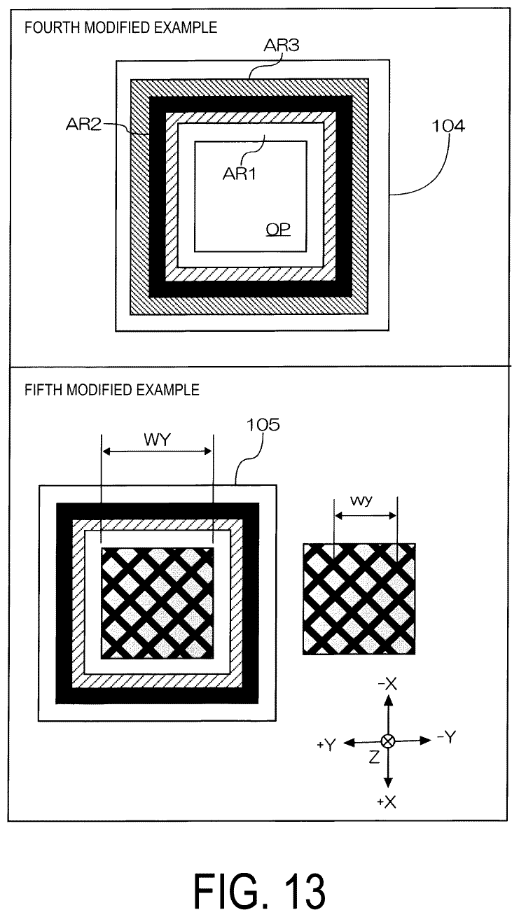

(B1) In the first embodiment described above, the window portion OP of the imaging jig 100 has a square shape. However, the shape may be a rectangular parallelepiped shape. Further, a polygonal shape such as a triangular shape and a pentagonal shape may be adopted. A circular shape, as it is, cannot specify the direction of field angle distortion, and thus cannot be adopted when the correction of field angle distortion is to be executed by using the shape of the window portion. However, when only correction other than field angle distortion, such as contrast correction, is executed, the circular shape cay be used. Further, when three or more markings are applied to the circular shape, field angle correction can be executed by using the markings. For example, as illustrated in a first modified example in FIG. 12, when the imaging jig 101 is formed to have a circular shape, a black border FL is provided on the outer periphery of the circular window portion OP, and three or more white notches MK are formed therein, the direction of field angle distortion can be specified by using the positions of the notches MK, and field angle distortion can be corrected. As a matter of course, when the correction of field angle distortion is executed without using the outer shape of the window portion OP, and is executed by using an imaging jig having a polygonal shape, for example, a rectangular shape, or the outer shape of the first region AR1 or the like, the shape of the window portion OP may be any shape.
(B2) In the embodiment described above, the size and shape of the first region AR1 and the like are assumed to be given in calculations for correction and the like in the image processing device 30. However, as illustrated in a second modified example in FIG. 12, scales SCX and SCY with known intervals may be displayed inside an imaging jig 102 along the X direction and the Y direction, and the imaging unit 20 may read the scales SCX and SCY from the captured image and treat the scales as the size of the first region AR1 and the like.
(B3) Further, as illustrated in a third modified example in FIG. 12, a code such as a QR code (registered trademark) may be recorded on an imaging jig 103. Then, by using this code qq, the imaging unit 20 may cause the image processing device 30 to recognize information relating to the imaging jig 103, such as the shape and size of the first region AR1 and the second region AR2, luminance, or the like from the captured image. In this case, the necessary information may be directly stored in the code, or various information may be acquired from an external site based on a URL of an online site described in the code. Note that the code qq is not limited to a two-dimensional code such as a QR code, but may be a one-dimensional code such as a barcode, or the information may be presented as text and read by the image processing device 30 using an OCR function. Further, an outer frame such as the first region AR1 may be printed in a predetermined color, and the color may be associated with the size of the outer frame.
(B4) In addition, as illustrated in a fourth modified example in FIG. 13, an imaging jig 104 may be provided with a third region AR3 having a tone or a hue that is different from those of the first region AR1 and the second region AR2. As illustrated in the drawing, the third region AR3 may be provided in the outermost periphery, and the position thereof is freely selected. When the third region AR3 is set to an intermediate gradation (typically gray) with respect to the gradation values of the first region AR1 and the second region AR2, the variations of noise adjustment that can be handled can be increased. For example, the color of the third region AR3 may be gray such as R. G. B=(64, 64, 64), R. G. B=(128, 128, 128), and R. G. B=(192, 192, 192). The third region AR3 may also be used as the buffer region AB of the imaging jig 100 described above. Further, by setting the third region AR3 to a predetermined color, the third region AR3 can also be used for correction of hue and saturation. The region to be added is not limited to the third region, and may be further increased to include fourth, fifth, and more regions.
(B5) Some imaging jigs including the imaging jigs 100 to 104 are presented, and the size of the window portion OP in each of the imaging jig may have such a size that can be used as a texture image. For example, the size is only required to be approximately 5 centimeters or more. FIG. 13 illustrates a case in which the subject TM has a pattern, and a cycle with which the pattern is repeated in the Y direction is wy as a fifth modified example. In this case, a length WY of the window portion OP in the Y direction, which is provided to an imaging jig 105 may be at least twice longer than the cycle wy of the pattern in the Y direction, in other words, WY>2·wy may be satisfied. This relationship is similarly applied to the dimension of the window portion OP in the X direction and the cycle of the pattern in the X direction.
(B6) In the description given above, the first region AR1 and the second region AR2 are white or black regions, and are mainly used as references for correction of contrast and correction of luminance. However, the subject TM being an imaging target may be colored, or may have a colored pattern on a white background. In such a case, when the white balance of the lighting is not appropriate, a color-related defect may occur in the captured image. In response to such a defect, the coloration of the pattern of the imaging jig is devised. With this, the defect can be resolved through image processing by the image processing device 30.

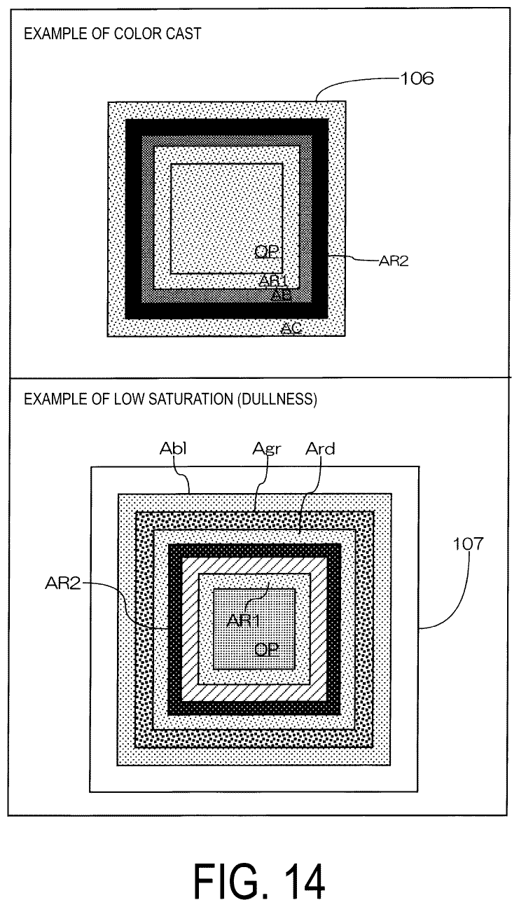

Typical color-related defects in pixels captured in an image include color cast and low saturation (dullness). How to address those defects is described below with reference to FIG. 14 as appropriate.

### Color Cast

Color cast mainly occurs due to a discrepancy between a lighting source at the time of imaging and a white balance on imaging equipment side. The upper part of FIG. 14 illustrates an example of the captured image when color cast occurs. In this case, in the imaging jig 106, except for the black second region AR2, the white first region AR1, the buffer region AB, a base color portion AC of the imaging jig 106 on the outer side of the second region AR2, and the portion of the subject TM visible through the window portion OP are captured in a state in which those regions are not white but colored. This is referred to as color cast. To address such color cast, correction by applying white balance with the image processing device 30 may be executed. The white balance correction processing in the image processing is well known. Thus, detailed description therefor is omitted. When a gray region with a known luminance value L exists in the region surrounding the window portion OP, the white balance correction can easily be executed by using such a gray region. When there is no gray region prepared, a white region such as the first region AR1 may be used, and the RGB balance may be adjusted so that no saturation occurs in the white region. As a matter of course, a user may be prompted to change a color temperature of a lighting device or the white balance on the imaging unit 20 side and to restart the processing from the imaging processing (FIG. 7, step S101).

### Low Saturation (Dullness)

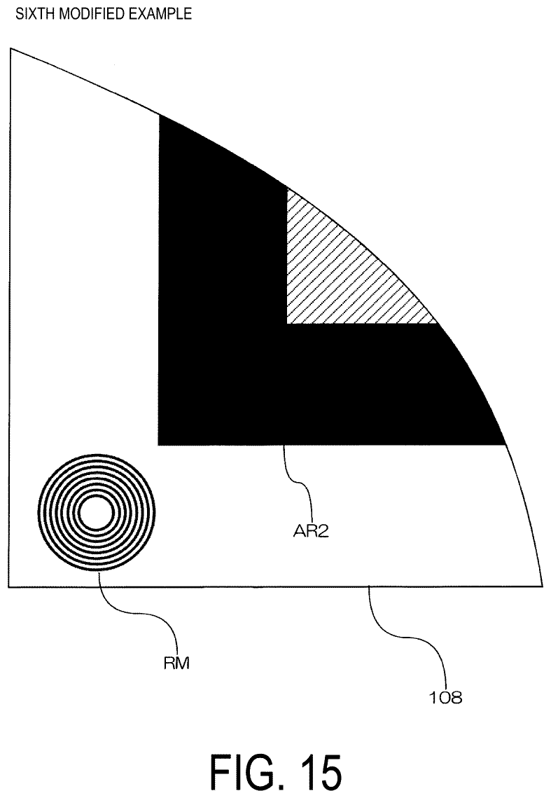

Another defect, low saturation (dullness), mainly occurs due to underexposure or the like. Therefore, when low saturation is detected, it may be effective to prompt a re-imaging instead of executing correction. The lower part of FIG. 14 illustrates an example in which a color region is provided to an imaging jig 107. In the illustrated example, on the outer side of the second region AR2, a red region Ard, a green region Agr, and a blue region Abl are provided in the stated order from the inner side. The hue and saturation of those regions are measured in advance, or color regions specified by an ICC profile are prepared by using a printer. The imaging jig 107 including those color regions overlap with on the subject TM, and is captured in an image by the imaging unit 20. Then, the red, green, and blue (RGB) regions are specified from the captured image by edge determination, and the RGB values are obtained. Lab values are calculated from those RGB values by using the ICC profile, and the measured Lab values and the Lab values at the time of color region creation are compared with each other. Then, the amount of saturation correction is determined, and saturation correction is executed. With this, low saturation (dullness) can be resolved. Note that the colors of the color regions formed on the imaging jig 107 are not necessarily limited to the R, G, and B that are illustrated. When the colors of the subject TM are known in advance, color regions may be formed by using colors similar to those of the subject TM. With this, high-accuracy saturation correction can be executed. Further, similarly to color cast and the like, a user may be prompted to restart the processing from the imaging processing (FIG. 7, step S101).
(B7) In each of the embodiments and modified examples described above, the imaging function of the imaging unit 20 is described as a single function. However, when a mobile terminal such as a smartphone is used as the imaging unit 20, the camera 25 mounted on the imaging unit 20 may be provided with lenses corresponding to a plurality of field angles, and may automatically switch the field angles depending on a target object, a distance to the target object, or the like. As an example of the camera capable of switching the field angles, a configuration provided with two or more lenses selected from a super-telephoto lens, a telephoto lens, a standard lens, a wide-angle lens, and a super-wide-angle lens, and the like is assumed. When a mobile terminal such as a smartphone can be used as the imaging unit 20, the texture image can easily be acquired. However, when the lenses to used are automatically switched according to an imaging distance and the like at the time of imaging, there is a possibility that an appropriate image of the subject TM with which the imaging jig 100 overlaps may not be acquired. Assuming the presence of such a camera 25, an example in which a predetermined pattern is provided in advance on the imaging jig is illustrated in FIG. 15. Note that at least part of switching of the field angles may involve not only switching the lenses of the camera but also switching between a plurality of cameras themselves when the plurality of cameras are provided.

In an imaging jig 108 illustrated herein, in the margin on the outer side of the second region AR2, specifically, at one corner (the lower-left in this case) of the rectangular imaging jig 108, a resolution evaluation pattern RM is provided. The resolution evaluation pattern RM includes at least an edge where a tone changes. Herein, a plurality of black circles are formed as concentric circles spaced at predetermined intervals. In this example, the camera 25 provided to the imaging unit 20 is provided as a camera including three types of field angles, specifically, telephoto, standard, and wide-angle. In an auto mode, the camera has a function of selecting one of the plurality of field angles, based on the distance to the subject TM or the set magnification. The image processing device 30 acquires, from the captured image of the imaging unit 20, an edge strength of the resolution evaluation pattern RM included in the captured image, and includes a program for executing resolution determination processing for determining that resolution is insufficient when the edge strength is equal to or less than a predetermined threshold value.

In the texture image acquisition apparatus 10 using the imaging jig 108, the resolution determination processing is executed in steps S101 to S115 of the texture image acquisition processing routine illustrated in FIG. 7. In the resolution determination processing, when a mobile terminal such as a smartphone is used as the imaging unit 20, and the camera 25 is automatically switched to a wide-angle or super-wide-angle setting, the resolution of the image acquired by the camera 25 is detected by using the resolution evaluation pattern RM. When the resolution is insufficient, a user is notified and prompted to switch the field angle of the camera to the telephoto side and execute imaging again. In the resolution evaluation pattern RM illustrated in the drawing, the intervals between the concentric circles are constant, but the intervals may be varied so that the resolution can be evaluated in a plurality of stages. Further, the pattern is not limited to the concentric circles, and may be a rectangular concentric pattern. Alternatively, two straight lines of a predetermined length separated by a predetermined distance may be used as the evaluation pattern, and those lines may be printed on the edge of the imaging jig. The resolution may then be determined based on the result of edge determination executed on the two line segments.
(B8) In each of the embodiments described above, some of the configurations implemented by the hardware may be replaced with software. Some of the configurations implemented by the software may be implemented by a discrete circuit configuration. Further, in a case where part of the functions or the entire functions of the present disclosure is achieved by the software, the software (computer program) may be provided in a form stored in a computer-readable recording medium. The term “computer-readable recording medium” is not limited to a portable recording medium such as a flexible disk and a CD-ROM, but includes various internal storage devices such as a RAM and a ROM and various external storage devices fixed to a computer such as a hard disk. In other words, “computer-readable recording medium” has a broad range of definition including any recording device capable of non-transitorily and fixedly storing a data packet.

The present disclosure is not limited to the above-described embodiments, and can be realized in various configurations without departing from the spirit of the present disclosure. For example, appropriate replacements or combinations may be made to the technical features in the embodiments which correspond to the technical features in the aspects described in the SUMMARY section to solve some or all of the problems described above or to achieve some or all of the advantageous effects described above. Further, even when technical characteristics are not described as essential ones in the present specification, it is possible to delete the technical characteristics in the embodiments appropriately.

What is claimed is:

1. A texture image acquisition apparatus configured to acquire a texture image of a medium, the texture image acquisition apparatus comprising:
an imaging jig including a comparison pattern surrounding a window portion configured as a light-transmissive region having a predetermined shape and including at least a first region and a second region having different tones;
an imaging unit configured to capture an image while the imaging jig overlaps with the medium, the image being an captured image including the medium in the window portion and the comparison pattern;
a correction unit configured to acquire, from the captured image, medium image data based on the image of the medium and comparison image data based on the image of the comparison pattern, and correct the medium image data, based on image data relating to the first region and the second region that are included in the comparison image data; and
an extraction unit configured to extract an image of a texture of the medium from the medium image data being corrected.

2. A texture image acquisition apparatus according to claim 1, wherein
the correction unit corrects the medium image data, based on actual density of the comparison pattern and the comparison image data.

3. A texture image acquisition apparatus according to claim 1, wherein
at least one of the first region and the second region that are included in the comparison pattern of the imaging jig is generated through printing by a printer, and a color including the tones printed by the printer can be identified by using an ICC profile.

4. A texture image acquisition apparatus according to claim 1, wherein
the extraction unit extracts, as the texture image, data relating to a pixel present within a predetermined acquisition range including the center point of the window portion included in the medium image data being corrected.

5. A texture image acquisition apparatus according to claim 4, wherein
the acquisition range is defined within the window portion, excluding at least part of pixels located in a predetermined range along an inner side of an outer periphery of the window portion.

6. A texture image acquisition apparatus according to claim 1, wherein
a target of the correction by the correction unit includes at least one of field angle distortion, unevenness caused by lighting, low contrast due to underexposure, defocus blur, luminance noise, and high-sensitivity noise that possibly occur in the medium image data during imaging by the imaging unit.

7. A texture image acquisition apparatus according to claim 1, wherein
the imaging jig includes a resolution evaluation pattern having at least a tone-transition edge, and
an edge strength of the resolution evaluation pattern included in the captured image is acquired from the captured image of the imaging unit, and resolution determination processing for determining that resolution is insufficient is executed when the edge strength is equal to or less than a predetermined threshold value.

8. A texture image acquisition apparatus according to claim 7, wherein
the imaging unit is a mobile terminal including a camera with a plurality of field angles and being configured to select any field angle of the plurality of field angles, based on a distance to a subject or a magnification, and
when the field angle in the imaging unit is selected, the resolution determination processing is executed.

9. A method of acquiring a texture image of a medium, the method comprising:
capturing an image while an imaging jig overlaps with the medium, the imaging jig including a comparison pattern surrounding a window portion configured as a light-transmissive region having a predetermined shape and including at least a first region and a second region having different tones, the image being an captured image including the medium in the window portion and the comparison pattern;
acquiring, from the captured image, medium image data based on the image of the medium and comparison image data based on the image of the comparison pattern, and correcting the medium image data, based on image data relating to the first region and the second region that are included in the comparison image data; and
extracting an image of a texture of the medium from the medium image data being corrected.

10. The method of acquiring a texture image according to claim 9, wherein
a target of the correction in the medium image data includes at least one of field angle distortion, unevenness caused by lighting, low contrast due to underexposure, defocus blur, luminance noise, and high-sensitivity noise that possibly occur in the medium image data during the imaging.

11. The method of acquiring a texture image according to claim 9, wherein
a target of the correction in the medium image data includes field angle distortion, inappropriate contrast, inappropriate luminance, and inappropriate sharpness that possibly occur in the medium image data during imaging, and correction of the field angle distortion, adjustment of the contrast, adjustment of the luminance, and adjustment of the sharpness are executed in the stated order.

12. A non-transitory computer-readable storage medium storing a computer-executable program for acquiring a texture image of a medium, the program being configured to achieve, with a computer:
a function of capturing an image from a subject in a state in which an imaging jig overlaps with the medium, the imaging jig including a comparison pattern surrounding a window portion configured as a light-transmissive region having a predetermined shape and including at least a first region and a second region having different tones, the image being an captured image including the medium in the window portion and the comparison pattern; and
acquiring, from the captured image, medium image data based on the image of the medium and comparison image data based on the image of the comparison pattern, and correcting the medium image data, based on image data relating to the first region and the second region that are included in the comparison image data; and
extracting an image of a texture of the medium from the medium image data being corrected.

13. An imaging jig for capturing an image of a texture of a medium, the imaging jig comprising:
a window portion being provided at the center of the imaging jig and being configured as a region having a predetermined shape; and
a comparison pattern surrounding the window portion and including at least a first region and a second region having different tones, wherein
the first region is circumscribed with the window portion to surround the window portion,
the second region surrounds the first region on the outer side with respect to the first region, and
outer peripheral shapes of the first region and the second region are similar to each other and share a center point with the window portion.

14. The imaging jig according to claim 13, wherein
the window portion is a window portion having a polygonal shape provided at the center of the imaging jig.

15. The imaging jig according to claim 14, wherein
the polygonal shape is a rectangular shape.

16. The imaging jig according to claim 14, wherein
the first region has an outer peripheral shape having a rectangular shape, and is circumscribed with the window portion to surround the window portion, and
the second region has an outer peripheral shape having a rectangular shape, and surrounds the first region on the outer side with respect to the first region.

17. The imaging jig according to claim 13, wherein
at least one of the first region and the second region is white black.

18. The imaging jig according to claim 13, wherein
each side of the window portion has a length that is at least twice longer than a width of a repetition period of tones provided in the medium.
